(19) United States
(12) Patent Application Publication
(10) Pub. No.: US 2015/0205936 A1
(43) Pub. Date: Jul. 23, 2015

(54) Technologies for Prescription Management

(71) Applicants: Daniel Eric Ford, West Chester, OH (US); Richard James Randall, Scottsdale, AZ (US); Matthew L. Wehrman, Cincinnati, OH (US); Sandra Jo Messerly, Cincinnati, OH (US); Jeremy T. Shubert, Liberty Township, OH (US); Mark Edward Patrick, Morrow, OH (US)

(72) Inventors: Daniel Eric Ford, West Chester, OH (US); Richard James Randall, Scottsdale, AZ (US); Matthew L. Wehrman, Cincinnati, OH (US); Sandra Jo Messerly, Cincinnati, OH (US); Jeremy T. Shubert, Liberty Township, OH (US); Mark Edward Patrick, Morrow, OH (US)

(21) Appl. No.: 14/258,731

(22) Filed: Apr. 22, 2014

Related U.S. Application Data
(60) Provisional application No. 61/929,002, filed on Jan. 17, 2014.

(51) Int. Cl. G06F 19/00

(52) U.S. Cl. CPC G06F 19/3481; G06Q 40/08

(57) ABSTRACT

Technologies for managing a drug prescription may include determining submission requirements to submit a prescription of a user to an insurance payer for payment based on an identity of the insurance payer, generating a prescription payment submission form customized for the insurance payer based on the submission requirements, populating the prescription payment submission form with prescription information of the prescription and identification information of the user, and submitting the populated prescription payment submission form to an insurance payer processor server. Additionally, the disclosed technologies include receiving prescription co-pay information related to the prescription in response to submitting the prescription payment submission form and submitting an adjustment to the insurance payer processor server to cancel the submission of the prescription payment submission form. The disclosed technologies also include prior authorization technologies for determining a requirement of prior authorization and obtaining the prior authorization. Additionally, patient assistance technologies are disclosed.

### CROSS-REFERENCE TO RELATED U.S. PATENT APPLICATIONS

The present application claims priority under 35 U.S.C. §119(e) to U.S. Provisional Patent Application Ser. No. 61/929,002, entitled “PRESCRIPTION MANAGEMENT SYSTEM” by Daniel Eric Ford, which was filed on Jan. 17, 2014, the entirety of which is hereby incorporated by reference.

### TECHNICAL BACKGROUND

The present disclosure relates, generally, to prescription management systems and methods and, more particularly, to patient benefit verification and prescription prior authorization systems and methods.

### BACKGROUND

Drug prescriptions are prescribed to patients by healthcare providers to alleviate a variety of ailments. Due to the ever rising cost associated with drug prescriptions, many patients rely on insurance plans supplied by insurance providers to help cover such costs. Many insurance plans require some contribution from the patient to cover a portion of the costs. Such required contribution is traditionally referred to as a “co-pay.” Depending on the insurance plan purchased by the patient and the particular drug prescribed in the drug prescription, the amount of the co-pay may vary. For example, in some situations, no co-pay may be required or may amount to a very low dollar contribution on part of the patient. However, in other situations, the co-pay requirement could amount to hundreds of dollars or more. Generally, the patient has little to no information regarding the co-pay requirement. Oftentimes, the patient may not even be aware of the co-pay requirement until the patient has already traveled to the local pharmacy and attempted to obtain the prescription. In such situations, the patient may be unable, or otherwise not ready, to contribute the required co-pay amount.

Additionally, depending on the insurance plan, the particular drug prescribed in the drug prescription, and/or other factors, the patient's insurance provider may require a prior authorization before the patient's drug prescription can be filled. As with the co-pay requirement, the requirement to obtain a prior authorization may be unknown by the patient and discovered only after the patient has attempted to fill the prescription at a pharmacy. Depending on the insurance provider, the prior authorization may require submission of particular prior authorization forms by the patient's healthcare provider and/or additional information that the patient may not have readily available. As such, the lack of knowledge of a prior authorization requirement can delay the patient in filling the prescription.

Due to the cost of many drug prescriptions, drug manufacturers and government entities provide various types of patient assistance. For example, some drug manufactures may provide vouchers for particular drugs (e.g., “name brand” drugs). Additionally, government entities may provide various support services to patients depending on, for example, the economic situation of the patient, the patient's aliment, the drug prescribed, and/or other criteria. Unfortunately, many patients are unaware of such patient assistance and have no easy access to becoming aware of such assistance.

### SUMMARY OF THE DISCLOSURE

According to one aspect, a method for managing a drug prescription includes determining, by a prescription management server, an identity of an insurance payer for the drug prescription; determining, by the prescription management server, submission requirements to submit a prescription of a user to the insurance payer for payment based on the identity of the insurance payer; and generating, by the prescription management server, a prescription payment submission form customized for the insurance payer based on the submission requirements. The method may also include populating, by the prescription management server, the prescription payment submission form with prescription information of the prescription and identification information of the user; submitting, by the prescription management server, the populated prescription payment submission form to an insurance payer processor server; and receiving, from the insurance payer processor server, prescription co-pay information related to the prescription in response to submitting the prescription payment submission form. Additionally, in some embodiments, the method may further include submitting, by the prescription management server and in response to receiving the co-pay information, an adjustment to the insurance payer processor server to cancel the submission of the prescription payment submission form and notifying, by the prescription management server, the user of the prescription co-pay information.

In some embodiments, determining submission requirements may include retrieving the submission requirements from a payer information database managed by the prescription management server based on the identity of the insurance payer. In such embodiments, the payer information database may identify submission requirements for a plurality of insurance payers. Additionally, in some embodiments, generating the prescription payment submission form may include modifying an electronic claim submission (ECS) field of the prescription payment submission form based on the identity of the insurance payer. Additionally, populating the prescription payment submission form may include populating an electronic claim submission (ECS) field of the prescription payment submission form based on at least one of the prescription information of the prescription, the identification information of the user, or the identity of the insurance payer.

Additionally, in some embodiments, submitting the populated prescription payment submission form may include identifying an insurance payer processor to process the populated prescription payment submission based on the identity of the insurance payer. Additionally or alternatively, submitting the populated prescription payment submission form may include submitting the populated prescription payment submission form to an insurance payer processor server using a National Provider Identification (NPI) associated with the prescription management server.

In some embodiments, the method may further include determining, by the prescription management server, whether a prior authorization for the prescription is required by the insurance payer based on the prescription information of the prescription and the identity of the insurance payer. For example, determining whether a prior authorization for the prescription is required may include receiving, from the insurance payer processor server, a notice that the prior authorization is required in response to submitting the prescription payment submission.

Additionally, in some embodiments, the method may further include determining, by the prescription management server and in response to determining that the prior authorization is required, authorization information required by the insurance payer to obtain the prior authorization; generating, by the prescription management server, a prior authorization submission form based on the authorization information; obtaining, by the prescription management server, a healthcare provider's approval of the prior authorization submission form; and submitting, by the prescription management server, the prior authorization submission form to the insurance payer processor server in response to obtaining the healthcare provider's approval for the prior authorization form. In some embodiments, obtaining the healthcare provider's approval of the prior authorization submission form may include transmitting the prior authorization submission form to the healthcare provider and receiving a signed prior authorization submission form from the healthcare provider.

The method may further include receiving, by the prescription management server, a prior authorization approval of the insurance payer from the insurance payer processor server and notifying, by the prescription management server, the user of the prior authorization approval. Additionally or alternatively, the method may further include determining, by the prescription management server, an availability of a prescription voucher for the prescription; obtaining, by the prescription management server, a voucher form for submitting the prescription voucher for reimbursement; populating, by the prescription management server, the voucher form based on the identification information of the user, and submitting, by the prescription management server, the voucher form to a drug manufacture server of a drug identified by the prescription. Further, the method may additionally or alternatively include determining, by the prescription management server, whether the user qualifies for patient assistance; obtaining, by the prescription management server, a patient assistance request form; populating, by the prescription management server, the patient assistance request form based on the identification information of the user and the prescription information of the prescription; and submitting, by the prescription management server, the assistance submission request form.

According to another aspect, a prescription management server may include a patient benefit verification module and a communication module. The patient benefit verification module may be configured to (i) determine an identity of an insurance payer for the drug prescription, (ii) determine submission requirements to submit a prescription of a user to the insurance payer for payment based on the identity of the insurance payer, (iii) generate a prescription payment submission form customized for the insurance payer based on the submission requirements, (iv) populate the prescription payment submission form with prescription information of the prescription and identification information of the user. Additionally, the communication module may be configured to (i) submit the populated prescription payment submission form to an insurance payer processor server and (ii) receive, from the insurance payer processor server, prescription co-pay information related to the prescription in response to submitting the prescription payment submission form. In some embodiments, the patient benefit verification module may be configured further to generate an adjustment to cancel the submission of the prescription payment submission form and notify the user of the prescription co-pay information. Additionally, the communication module may be configured further to submit the adjustment to the insurance payer processor server.

In some embodiments, the prescription management server may also include a payer information database that identifies submission requirements for a plurality of insurance payers. In such embodiments, to determine the submission requirements may include to retrieve the submission requirements from the payer information database based on the identity of the insurance payer. Additionally, in some embodiments, to generate the prescription payment submission form may include to modify an electronic claim submission (ECS) field of the prescription payment submission form based on the identity of the insurance payer. Additionally or alternatively, to populate the prescription payment submission form may include to populate an electronic claim submission (ECS) field of the prescription payment submission form based on at least one of the prescription information of the prescription, the identification information of the user, or the identity of the insurance payer.

Additionally, in some embodiments, the patient benefit verification module may be further configured to identify an insurance payer processor to process the populated prescription payment submission based on the identity of the insurance payer. In some embodiments, to submit the populated prescription payment submission form may include to submit the populated prescription payment submission form to an insurance payer processor server using a National Provider Identification (NPI) associated with the prescription management server.

Additionally, in some embodiments, the prescription management server may further include a prescription prior authorization module configured to determine whether a prior authorization for the prescription is required by the insurance payer based on the prescription information of the prescription and the identity of the insurance payer. In such embodiments, to determine whether a prior authorization for the prescription is required may include to receive, from the insurance payer processor server, a notice that the prior authorization is required in response to submitting the prescription payment submission. Additionally or alternatively, the prescription prior authorization module may be further configured to determine, in response to a determination that the prior authorization is required, authorization information required by the insurance payer to obtain the prior authorization; generate a prior authorization submission form based on the authorization information; and obtain a healthcare provider's approval of the prior authorization submission form. In such embodiments, the communication module may be configured to submit the prior authorization submission form to the insurance payer processor server in response to the healthcare provider's approval of the prior authorization form.

In some embodiments, to obtain the healthcare provider's approval of the prior authorization submission form may include to transmit, by the communication module, the prior authorization submission form to the healthcare provider and receive, by the communication module, a signed prior authorization submission form from the healthcare provider. Additionally, in some embodiments, the communication module may be further configured to receive a prior authorization approval of the insurance payer from the insurance payer processor server, and the prescription prior authorization module may be further configured to notify the user of the prior authorization approval.

Additionally, in some embodiments, the prescription management server may further include a patient assistance module to determine an availability of a prescription voucher for the prescription; obtain a voucher form for submitting the prescription voucher for reimbursement; and populate the voucher form based on the identification information of the user. In such embodiments, the communication module may be further configured to submit the voucher form to a drug manufacture server of a drug identified by the prescription. Further, in some embodiments, the prescription management server may further include a patient assistance module configured to determine whether the user qualifies for patient assistance; obtain a patient assistance request form; and populate the patient assistance request form based on the identification information of the user and the prescription information of the prescription. In such embodiments, the communication module may be configured to submit the assistance submission request form.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for managing prescriptions;

FIG. 2 is a simplified block diagram of at least one embodiment of an environment of a prescription management server of the system of FIG. 1;

FIGS. 3-6 are simplified flow diagrams of at least one embodiment of a method for managing a drug prescription of a user that may be executed by the prescription management server of FIG. 2; and

FIGS. 7-8 are simplified flow diagrams of at least one embodiment of a method for managing patient assistance services that may be available to the user and which may be executed by the prescription management server of FIG. 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); or (A, B, and C). Similarly, items listed in the form of “at least one of A, B, or C” can mean (A); (B); (C): (A and B); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

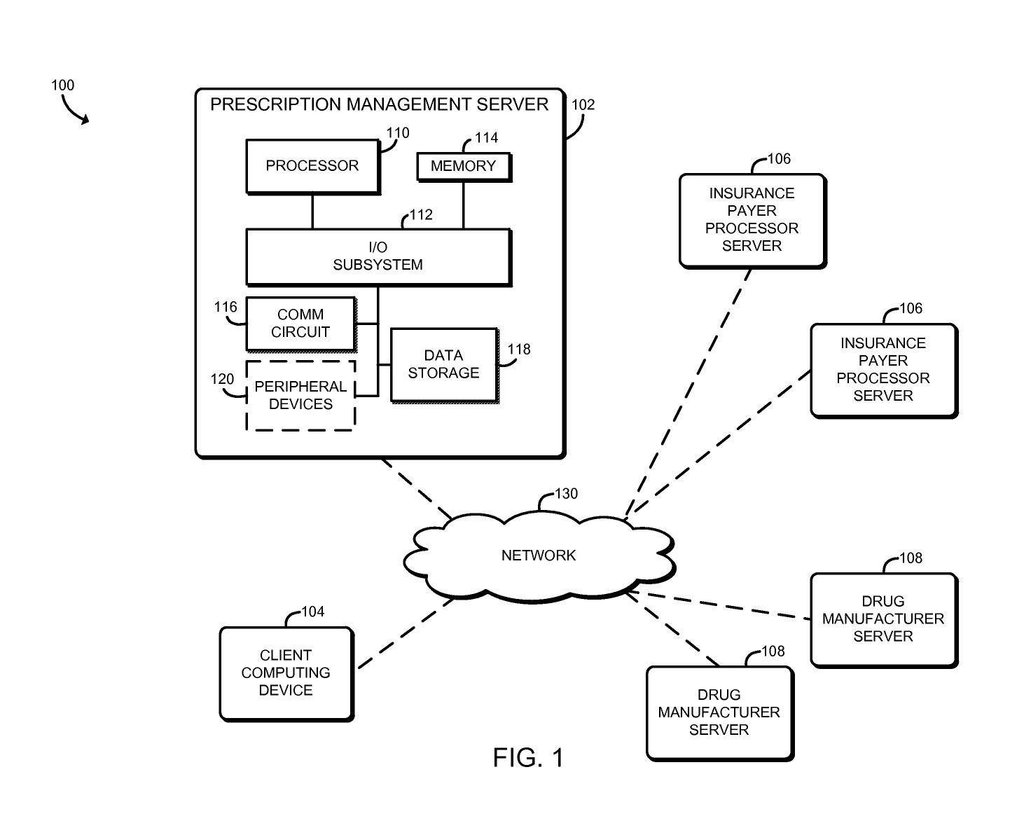

Referring now to FIG. 1, an illustrative system 100 for managing drug prescriptions of a patient includes a prescription management server 102, a client computing device 104 usable by the patient, and one or more insurance payer processor servers 106. Additionally, in some embodiments, the system 100 may include one or more drug manufacture servers 108. Each of the prescription management server 102, the client computing device usable by the patient, the insurance payer processor servers 106, and the drug manufacture servers 108 may communicate with each other over a network 130. In the illustrative embodiment, the prescription management server 102 provides patient benefit and prior authorization management services to a user of the client computing device 104 (i.e., a patient). To do so, the user may operate the client computing device 104 to interact with the prescription management server 102 to discover patient benefits, prior authorization requirements, and/or patient assistance services. The prescription management server 102 determines submission requirements for submitting a drug prescription to the user's insurance payer (e.g., the user's insurance provider or company) for payment or reimbursement. Each insurance payer may have different submission requirements, which can be quite confusing for a user to determine on their own. The prescription management server 102 generates a prescription payment submission form to submit the prescription to the insurance payer based on the submission requirements. That is, the prescription payment submission form is customized to the particular insurance payer used by the user. For example, various data fields may be included or excluded from the submission form or located in particular locations on the submission form based on the submission requirements of the particular insurance payer.

The prescription management server 102 populates the prescription payment submission form with prescription information and identification information of the user. In this way, the prescription management server 102 automates, at least to some degree, the process of completing the prescription payment submission form for the user. In some embodiments, little or no user interaction is required to complete the prescription payment submission form. However, in other embodiments, the user may supply some information (e.g., the prescription information) to the prescription management server 102 to facilitate completion of the prescription payment submission form. After the prescription payment submission form is completed, the prescription management server 102 submits the prescription payment submission form to an insurance payer processor server 106 for processing. In some embodiments, the insurance payer processor server 106 may be maintained by the insurance company providing the insurance policy to the user. However, in other embodiments, the insurance payer processor server 106 is maintained by a third party whom specializes in processing insurance payment submissions, typically for a large number of different insurance companies. The prescription management server 102 may determine which insurance payer processor to which to send the prescription payment submission form based on a rule policy (e.g., based on the user's insurance company, the particular drug prescribed in the drug prescription, etc.).

In response to receiving the prescription payment submission form, the insurance payer processor (or the insurance payer itself) determines whether a co-pay is required by the insurance payer for the particular drug prescription. As discussed above, some insurance payers may require varying amounts of a co-pay by the user (i.e., the patient) for particular drug prescriptions. As such, the insurance payer processor informs the prescription management server 102 of any co-pay requirements (e.g., no co-pay or the dollar amount of the co-pay) in response to the prescription payment submission form. The prescription management server 102 subsequently notifies the user of the co-pay requirement. Additionally, to cancel out the submission of the prescription payment submission such that the insurance provider does not complete the payment of the prescription, the prescription management server 102 submits an adjustment to the insurance payer processor to “back out” the prior prescription submission. In this way, the prescription management server 102 is able to determine whether a user is required to make a co-pay for a particular prescription without requiring payment of the prescription payment submission by the insurance provider.

In addition to the co-pay requirements, the prescription management server 102 may receive notification from the insurance payer processor whether any prior authorization is required by the insurance payer for the submitted prescription. As discussed above, some insurance payers may require the user (i.e., the patient) to receive a prior authorization from the insurance payer before the prescription is filled. Prior authorization typically requires additional information from the patient and/or the patient's healthcare provider. As discussed in more detail below, if prior authorization is required, the prescription management server 102 is configured to facilitate submission of a prior authorization form to the insurance payer processor. For example, the prescription management server 102 may generate or retrieve the appropriate form, auto-populate the prior authorization submission form with patient and/or prescription information, transmit the prior authorization submission form to the patient's healthcare provider for review and signing, and transmit the completed prior authorization submission form to the insurance payer processor. In this way, the user can be assured of obtaining any required prior authorization prior to attempting to fill the prescription at a pharmacy.

Additionally, as discussed in more detail below, the prescription management server 102 may facilitate patient assistance services for the user. For example, the prescription management server 102 may identify and complete manufacture vouchers for a drug prescribed by the prescription. Additionally or alternatively, the prescription management server 102 may facilitate the user in obtaining patient assistant services, which may be offered by government entities or other third-party entities.

The prescription management server 102 may be embodied as any type of server computer or computer device capable of managing prescriptions of a user and performing the other functions described including, without limitation, a computer, a multiprocessor system, a server, a rack-mounted server, a blade server, a laptop computer, a notebook computer, a network appliance, a web appliance, a distributed computing system, a processor-based system, and/or a consumer electronic device. As such, the prescription management server 102 may be embodied as a single server computing device or a collection of servers and associated devices. For example, in some embodiments, the prescription management server 102 may be embodied as a “virtual server” formed from multiple computing devices distributed across the network 130 and operating in a public or private cloud. Accordingly, although the prescription management server 102 is illustrated in FIG. 1 as embodied as a single server computing device, it should be appreciated that the prescription management server 102 may be embodied as multiple devices cooperating together to facilitate the functionality described below.

As shown in FIG. 1, the illustrative prescription management server 102 includes a processor 110, an input/output subsystem 112, a memory 114, a communication circuit 116, a data storage 118, and one or more peripheral device 120 in some embodiments. Of course, the prescription management server 102 may include other or additional components, such as those commonly found in a server device (e.g., various input/output devices), in other embodiments. Additionally, in some embodiments, one or more of the illustrative components may be incorporated in, or otherwise form a portion of, another component. For example, the memory 114, or portions thereof, may be incorporated in one or more processor 110 in some embodiments.

The processor 110 may be embodied as any type of processor capable of performing the functions described herein. For example, the processor may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the server 102 such as operating systems, applications, programs, libraries, and drivers. The memory 114 is communicatively coupled to the processor 110 via the I/O subsystem 112, which may be embodied as circuitry and/or components to facilitate input/output operations with the processor 110, the memory 114, and other components of the server 102. For example, the I/O subsystem 112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The communication circuit 116 may be embodied as any communication circuit, device, or collection thereof, capable of enabling communications between the prescription management server 102 and the client computing device 104, the insurance payer processor servers 106, and/or the drug manufacturer servers 108 over the network 130. Depending on the particular type of communication modalities supported by the prescription management server 102, the communication circuit 116 may be embodied as, or otherwise include, a data communication circuit, a cellular communication circuit, and/or other communication circuit technologies. As such, the communication circuit 116 may be configured to use any one or more suitable communication technology (e.g., wireless or wired communications) and associated protocols (e.g., GSM, CDMA, Ethernet, Bluetooth®, Wi-Fi®, WiMAX, etc.) to effect such communication.

The data storage 118 may be embodied as any type of device or devices configured for short-term or long-term storage of data such as, for example, memory devices and circuits, memory cards, hard disk drives, solid-state drives, or other data storage devices. The data storage 118 may store various applications, program files, and other data used by the server 102. In the illustrative embodiment, the data storage 118 stores various policy databases, rulesets, or “rules engines” for determining various data associated with the management of the patient's prescription including, but not limited to, insurance payer submission requirements, the appropriate insurance payer processor to handle a particular prescription payment submission, and the availability of prescription assistance services. Additionally, the data storage 118 may store various data such as, for example, user identification information, insurance plan information, prescription information associated with a particular drug prescription, and/or other data.

The prescription management server 102 may also include one or more peripheral devices 120 in some embodiments. Such peripheral devices 120 may include any type of peripheral device commonly found in a typical computer device, such as various input/output devices. For example, the peripheral devices 120 may include various input buttons and switches, a keyboard, a mouse, speaker, microphone, and/or other peripheral devices.

The client computing device 104 may be embodied as any type of computing device capable of facilitating communication with the prescription management server 102 and performing the functions described herein. For example, the client computing device 104 may be embodied as a smartphone, a cellular phone, a tablet computer, a notebook computer, a laptop computer, a desktop computer, a distributed computing system, a multiprocessor system, a consumer electronic device, a smart appliance, and/or any other computing device capable of communicating with the prescription management server 102. The client computing device 104 may include components commonly found in a client computing device or other computer device such as, for example, a processor, memory, I/O subsystem, communication circuit, data storage, peripheral devices, and/or other components. Such components of the client computing device 104 may be similar to the corresponding components of the prescription management server 102, the description of which is applicable to the corresponding components of the client computing device 104 and is not repeated herein so as not to obscure the present disclosure.

In use, the client computing device 104 may be operated by a user to communicate with the prescription management server 102 to manage drug prescriptions. For example, as discussed in more detail below, the user of the client computing device 104 may communicate with the prescription management server 102 to determine whether a particular drug prescription requires a co-pay and/or prior authorization.

Each of the insurance payer processor servers 106 may be embodied as any type of server computer or computer device capable of performing the functions described herein. Similar to the prescription management server 102, each insurance payer processor server 106 may be embodied as, without limitation, a computer, a multiprocessor system, a server, a rack-mounted server, a blade server, a laptop computer, a notebook computer, a network appliance, a web appliance, a distributed computing system, a processor-based system, and/or a consumer electronic device. Additionally, each insurance payer processor server 106 may be embodied as a single server computing device or a collection of servers and associated devices. Each insurance payer processor server 106 may include components commonly found in a server computer or other computer device such as, for example, a processor, memory, I/O subsystem, communication circuit, data storage, peripheral devices, and/or other components. Such components of the insurance payer processor servers 106 may be similar to the corresponding components of the prescription management server 102, the description of which is applicable to the corresponding components of the insurance payer processor servers 106 and is not repeated herein so as not to obscure the present disclosure.

Each insurance payer processor server 106 may be operated and maintained by an insurance provider or a third-party processor of insurance claims. For example, in the illustrative embodiment, the insurance payer processor servers 106 are maintained by one or more insurance payer processors, each of whom specialize in processing insurance claims (e.g., prescription payment submissions) for one or more insurance providers. In this way, insurance providers outsource the processing of insurance payment submissions. In use, as discussed in more detail below, the insurance payer processor severs receive prescription payment submissions from the prescription management server 102, determine co-pay requirements and/or prior authorization requirements based on the prescription, insurance policy, insurance provider, and/or other criteria, and transmits such information back to the prescription management server 102.

Similar to the insurance payer processor servers 106, each of the drug manufacturer servers 108 may be embodied as any type of server computer or computer device capable of performing the functions described herein. Each drug manufacturer server 108 may be embodied as, without limitation, a computer, a multiprocessor system, a server, a rack-mounted server, a blade server, a laptop computer, a notebook computer, a network appliance, a web appliance, a distributed computing system, a processor-based system, and/or a consumer electronic device. Additionally, each drug manufacturer server 108 may be embodied as a single server computing device or a collection of servers and associated devices. Each drug manufacturer server 108 may include components commonly found in a server computer or other computer device such as, for example, a processor, memory, I/O subsystem, communication circuit, data storage, peripheral devices, and/or other components. Such components of the drug manufacturer servers 108 may be similar to the corresponding components of the prescription management server 102, the description of which is applicable to the corresponding components of the drug manufacturer server 108 and is not repeated herein so as not to obscure the present disclosure.

Each drug manufacturer server 108 may be operated and maintained by a manufacturer of prescription drugs. In use, as discussed in more detail below, the prescription management server 102 may direct the user of the client computing device 104 (i.e., the patient) to a manufacturer website maintained by one of the drug manufacturer servers 108 and/or retrieve information from the drug manufacturer server 108 to assist the user in managing or filling a drug prescription. For example, in some embodiments, the drug manufacturer server 108 may maintain vouchers for particular prescription drugs, which may be submitted by the user to receive a discount or rebate of a prescription of such prescription drugs. In some embodiments, the prescription management server 102 may maintain the drug manufacturer website, rather than or in addition to the drug manufacturer server 108.

As discussed, the prescription management server 102, the client computing device 104, the insurance payer processor servers 106, and/or the drug manufacturer servers 108 may communicate with each over the network 130. The network 130 may be embodied as any number of various wired and/or wireless voice and/or data networks. For example, the network 130 may be embodied as, or otherwise include, a cellular network, wired or wireless local area network (LAN), a wired or wireless wide area network (WAN), and/or a publicly-accessible, global network such as the Internet. As such, the network 130 may include any number of additional devices, such as additional computers, routers, and switches to facilitate communications among the servers and devices of the system 100.

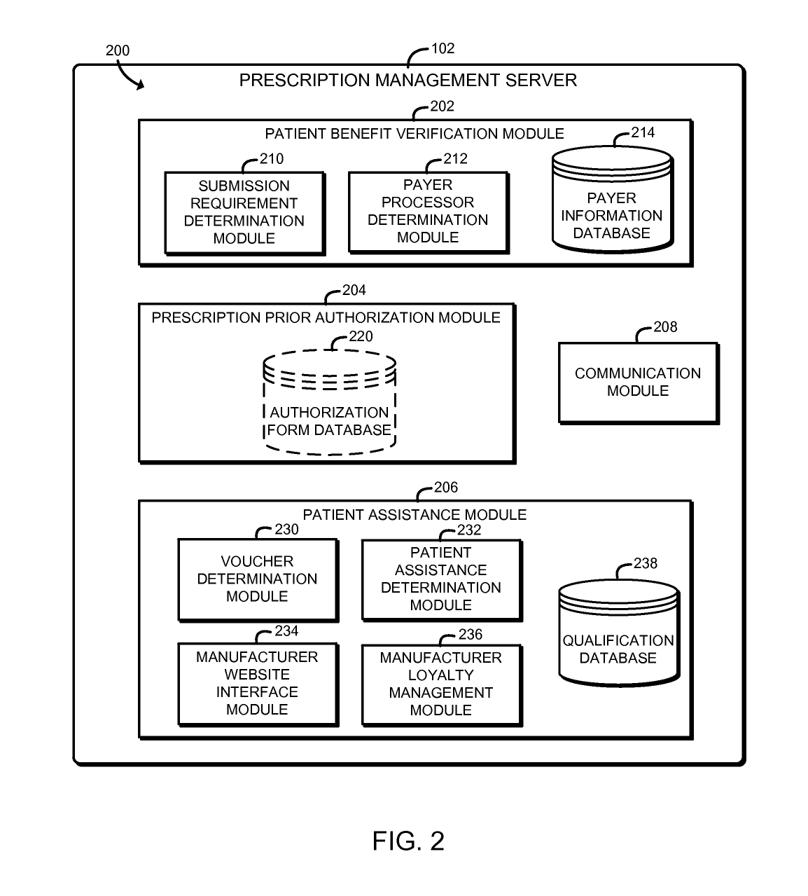

Referring now to FIG. 2, in the illustrative embodiment, the prescription management server 102 establishes an environment 200 during operation. The illustrative environment 200 includes a patient benefit verification module 202, a prescription prior authorization module 204, a patient assistance module 206, and a communication module 208. Each of the patient benefit verification module 202, the prescription prior authorization module 204, the patient assistance module 206, and the communication module 208 of the environment 200 may be embodied as hardware, firmware, software, or a combination thereof.

The patient benefit verification module 202 manages benefits of the patient under one or more insurance plans. For example, as discussed in more detail below, the patient benefit verification module 202 is configured to determine whether a particular prescription requires a co-pay by an insurance provider of the user. The patient benefit verification module 202 includes a submission requirement determination module 210 and a payer processor determination module 212, each of which may be embodied as hardware, firmware, software, or a combination thereof. The patient benefit verification module 202 also includes a payer information database 214, which may store various data, policy rules, and other information as discussed in more detail below.

The submission requirement determination module 210 is configured to determine submission requirements of the insurance payer of the patient's insurance plan. The submission requirements identify the particular data and format of such data as required by the insurance payer and/or the insurance payer processor. For example, such submission requirements may identify the type and/or location of data files on a prescription payment submission form. In the illustrative embodiment, the submission requirements identify the type of electronic claim submission (ECS) fields required by the insurance payer. The ECS fields are predetermined data fields for use in submitting electronic claims to an insurance payer. To determine the submission requirements, the submission requirement determination module 210 compares the insurance payer of the patient's insurance plan to a policy ruleset maintained in the payer information database 214. That is, the payer information database 214 may include policies and/or rules that identify submission requirements for each of a number of different insurance payers. Based on the determined submission requirements, the patient benefit verification module 202 generates (or retrieves) a prescription payment submission form customized for the patient's insurance payer and auto-populates the submission form with information (e.g., user and/or prescription information) as discussed in more detail below.

The payer processor determination module 212 is configured to determine an appropriate insurance payer processor to receive the prescription payment submission form. To do so, the payer processor determination module 212 may compare the insurance provider of the patient to a policy ruleset maintained in the payer information database 214. That is, the payer information database 214 may include policies and/or rules that identify an insurance payer processor for each of a number of different insurance payers.

After the appropriate payer processor has been determined by the payer processor determination module 212, the patient benefit verification module 202 transmits the prescription payment submission form to the identified insurance payer processor (i.e., to the appropriate insurance payer processor server 106) via the communication module 208. In response to the submission, the patient benefit verification module 202 determines whether a co-pay is required for the particular prescription based on received communications from the insurance payer processor server 106 and notifies the user of the client computing device 104 of the co-pay requirements as discussed in more detail below.

The prescription prior authorization module 204 is configured to determine whether a prior authorization is required for the user's drug prescription and facilitate submission of a prior authorization submission form if prior authorization is required. To do so, the prescription prior authorization module 204 monitors the responsive communication from the insurance payer processor server 106 for any prior authorization requirements. If a prescription prior authorization module 204 determines that a prior authorization is required for the particular drug prescription, the prescription prior authorization module 204 facilitates the submission of a prior authorization. For example, the prescription prior authorization module 204 may generate or retrieve an appropriate prior authorization submission form, auto-populate the prior authorization submission form with information (i.e., user and/or prescription information), and transmit the authorization form to the user's healthcare provider for review and signature. After the signed prior authorization submission form is received back from the user's healthcare provider, the prescription prior authorization module 204 may transmit the signed prior authorization submission form to the insurance payer processor server 106 via the communication module 208. In some embodiments, the prescription prior authorization module 204 may maintain prior authorization submission forms in an authorization form database 220.

The patient assistance module 206 is configured to facilitate patient assistance services for the user of the client computing device 104. The patient assistance module 206 includes a voucher determination module 230, a patient assistance determination module 232, a manufacturer website interface module 234, and a manufacturer loyalty management module 236, each of which may be embodied as hardware, firmware, software, or a combination thereof. Additionally, the patient assistance module 206 may maintain a qualification database 238.

The voucher determination module 230 is configured to determine whether a manufacturer voucher is available for a drug prescribed in the user's drug prescription. To do so, the voucher determination module 230 may access data stored by one or more of the drug manufacturer servers 108 to determine whether a manufacturer voucher is available and obtain any available manufacturer voucher from the servers 108. Alternatively, in some embodiments, the voucher determination module 230 may store manufacturer vouchers in the qualification database 238. The manufacturer voucher may provide a rebate or discount to the user of the client computing device 104 for the drug prescription as discussed above. The voucher determination module 230 may be configured to auto-populate the manufacturer voucher (e.g., with user and/or prescription information) and submit the manufacturer voucher on behalf of the user.

The patient assistance determination module 232 is configured to determine the availability of various assistance services and/or programs that may be available the user (i.e., the patient). To do so, the patient assistance determination module 232 may access other remote servers or data sources (e.g., servers maintained by government assistance services) to determine the availability of any assistance services. Additionally, the patient assistance determination module 232 may retrieve and/or generate assistance program submission forms and facilitate the completion of such forms for the user (e.g., by auto-populating data files of such assistance program submission forms.)

The manufacturer website interface module 234 is configured to link the user to one or more of the drug manufacturer servers 108 and/or provide customization of data presentation to the user and/or manufacturer webpages maintained by the prescription management server 102. Similarly, the manufacturer loyalty management module 236 maintains loyalty programs offered by a drug manufacturer. By participating in such loyalty programs, a user may obtain additional manufacturer vouchers or other discounts on a drug prescription.

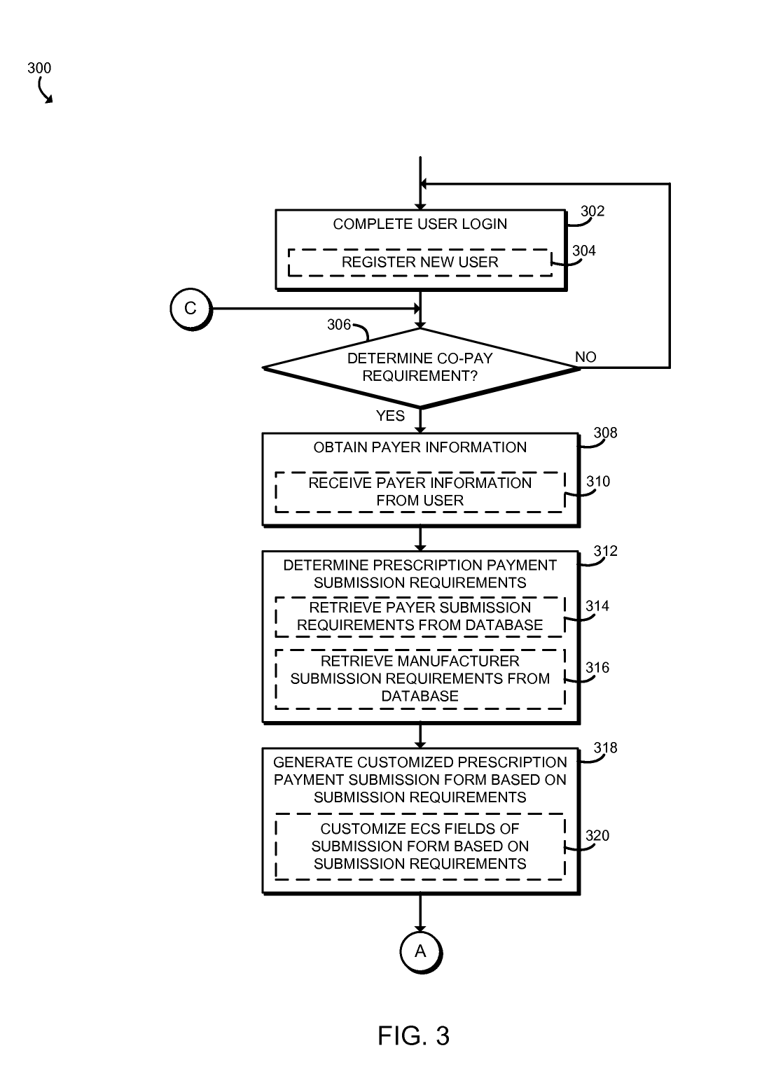

Referring now to FIGS. 3-6, in use, the prescription management server 102 may execute a method 300 for managing a drug prescription of a user. The method 300 begins with block 302 in which the prescription management server 102 completes a user login. That is, a user of the client computing device 104 (i.e., a patient) may log into the prescription management server 102 by submitting login information. In this way, identification information associated with the user may be maintained by the prescription management server 102, rather than requested by the prescription management server 102 periodically. If the user is a new user, the user may register with the prescription management server 102 in block 304. In such a registration process, the user may provide user identification information (e.g., user name, user address, etc.), insurance payer information (insurance policy number, insurance payer name, etc.), drug prescription information, and/or other information such that the user is not required to repeatedly provide such information to the prescription management server 102.

In block 306, the prescription management server 102 determines whether the user desires to determine whether a particular drug prescription requires a co-pay. If so, the method 300 advances to block 308 in which the prescription management server 102 obtains insurance payer information. To do so, the prescription management server 102 may query the user of the client computing device 104 for the insurance payer information. In such embodiments, the prescription management server 102 receives the insurance payer information from the user in block 310. Alternatively, in those embodiments in which the user has previously registered with the prescription management server 102, the prescription management server 102 may retrieve the insurance payer information from stored data related with the user.

In block 312, the prescription management server 102 determines submission requirements to submit a prescription of the user to the insurance payer for payment. To do so, the prescription management server 102 may retrieve insurance payer submission requirements from the payer information database 214, which may be stored in the data storage 118, based on the identity of the insurance payer in block 314. As discussed above, the payer information database 214 may store policy rules that identify submission requirements for particular insurance payers. Additionally or alternatively, the prescription management server 102 may determine submission requirements of the drug manufacturer of a drug prescribed in the drug prescription in block 316. Such manufacturer submission requirements may be retrieved from the data storage 118 or from a drug manufacturer server 108. As discussed above, the submission requirements identify requirements, such as the type and/or arrangement of data of a prescription payment submission to be authorized by the insurance payer. Such submission requirements may include, for example, which electronic claim submission (ECS) fields should be used, the location of such fields, and/or other data (e.g., identity data of the user, drug prescription, healthcare provider, etc.) that must be included in any prescription payment submission.

In block 318, the prescription management server 102 generates a prescription submission form based on the submission requirements determined in block 312. Because the prescription payment submission form is generated based on the submission requirements, the prescription payment submission form is customized for the particular insurance payer of the insurance policy held by the user. For example, in block 320, the prescription management server 102 may customize the electronic claim submission (ECS) fields of the prescription payment submission form based on the determined submission requirements. In this way, the prescription management server 102 may generate proper prescription payment submission forms customized based on the requirements of each insurance payer. In some embodiments, the prescription management server 102 may also pre-populate data fields of the prescription payment submission form using data stored by the prescription management server 102 such as, for example, user information, prescription information, healthcare provider information, insurance payer information, etc.

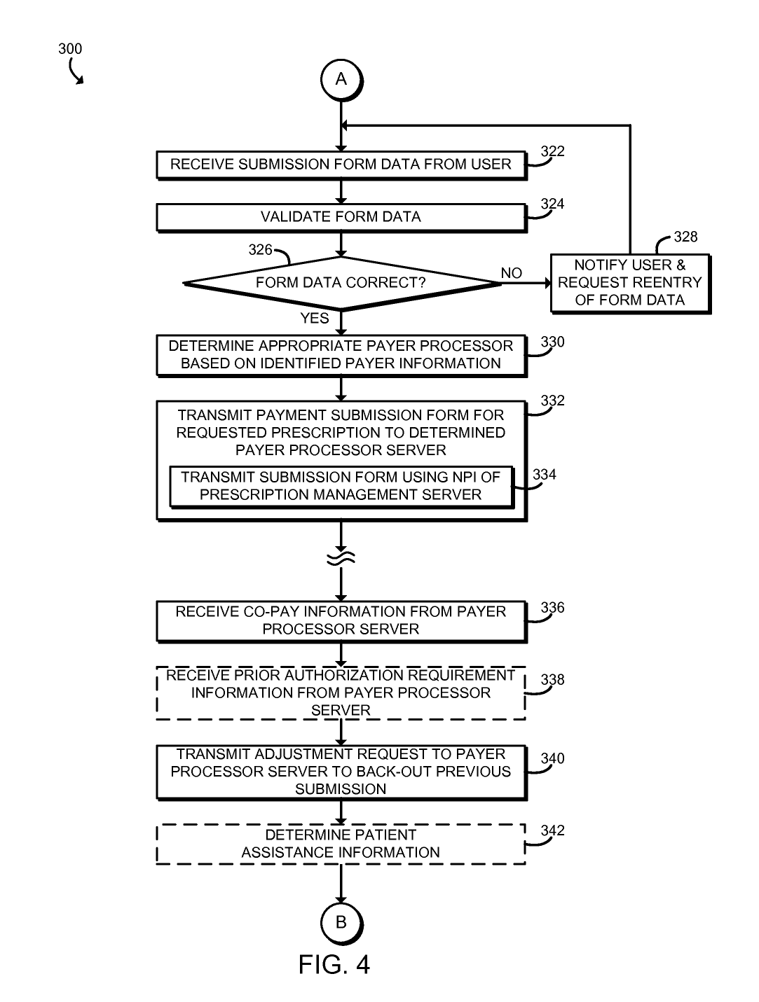

After the prescription management server 102 has generated the customized prescription payment submission form in block 318, the method 300 advances to block 322 of FIG. 4. In block 322, the prescription management server 102 receives any further prescription payment submission form data required to complete the submission form from the user of the client computing device 104 (e.g., the patient). In block 324, the prescription management server 102 may validate the completed submission form data. To do so, the prescription management server 102 may perform various analysis of the entered data for accuracy and completeness. For example, in some embodiments, the prescription management server 102 may verify the form data, or portion thereof, based on the submission requirements determined in block 312.

If the prescription management server 102 determines that the prescription payment submission form data is not correct in block 326, the prescription management server 102 notifies the user of the client computing device 104 in block 328 and requests the user to reenter the erroneous form data. The method 300 subsequently loops back to block 322 to receive new or replacement form data from the user of the client computing device 104.

If, however, the prescription management server 102 determines that the prescription payment submission form data is correct in block 326, the method 300 advances to block 330 in which the prescription management server 102 determines the appropriate insurance payer processor to receive the prescription payment submission form. To do so, the prescription management server 102 may compare the identity of the insurance payer to a policy ruleset stored in the payer information database 214 to determine the appropriate insurance payer processor to receive prescription payment submission for that particular insurance payer. In this way, the prescription management server 102 can support the use of a large variety of insurance payer processors and associated insurance payers with minimal or no interaction from the user of the client computing device 104.

After the appropriate insurance payer processor is determined in block 330, the prescription management server 102 transmits the prescription payment submission form to the insurance payer processor server 106 determined in block 330. To do so, the prescription management server 102 may utilize a National Provider Identification (NPI) associated with the prescription management server 102 or company maintaining the server 102 in block 334. The National Provider Identification is a unique identifier assigned to various healthcare providers such as hospitals and pharmacies. By using the National Provider Identification, the prescription management server 102 is able to submit directly the prescription payment submission form to the insurance payer processor on behalf of the user of the client computing device 104.

After the prescription management server 102 has submitted the prescription payment submission form to the insurance payer processor, the insurance payer processor will process the submission and determine any further requirements, such as any co-pay requirements and/or prior authorizations required by the insurance payer of the insurance policy held by the user of the client computing device 104. As such, in block 336, the prescription management server 102 receives co-pay information from the insurance payer processor server 106 in response to prescription payment submission form. The co-pay information identifies any co-pay requirements that the user of the client computing device 104 may have for the submitted drug prescription. As discussed above, some insurance payers may require co-pays of varying amounts based on the particular drug prescribed in the drug prescription (e.g., if the prescribed drug is a “name brand” version of the drug). In some embodiments, the prescription management server 102 may also receive prior authorization requirement information from the insurance payer processor server 106 in response to prescription payment submission form in block 338. Again, as discussed above, depending on the particular drug prescription, some insurance payers may require acceptance of a prior authorization before the user can fill the prescription. As discussed above, the prior authorization may require additional or particular information not included in the prescription payment submission form.

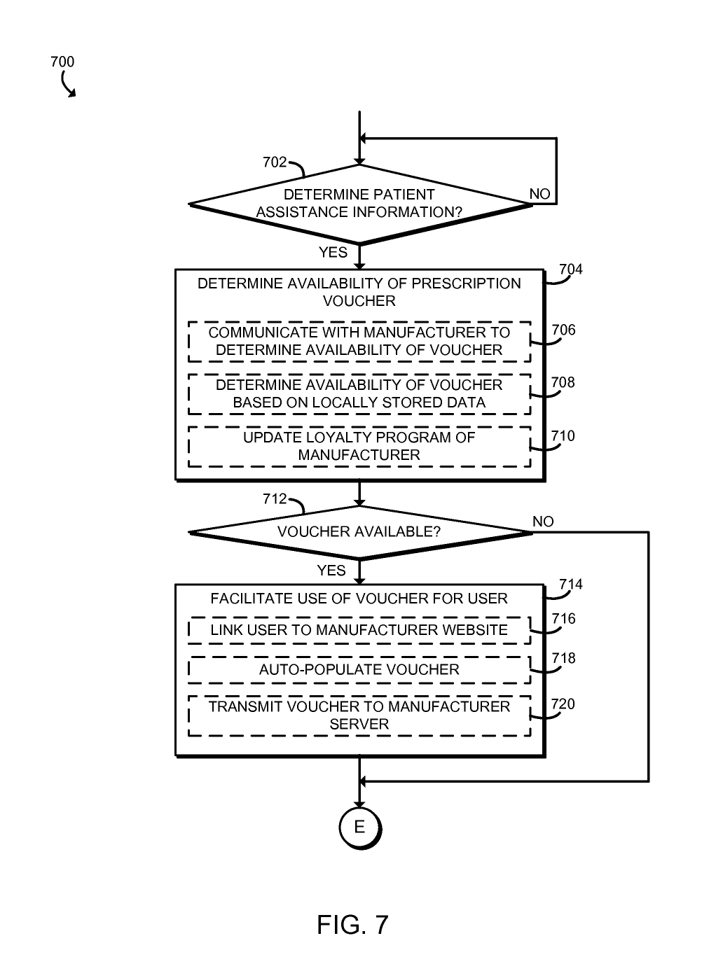

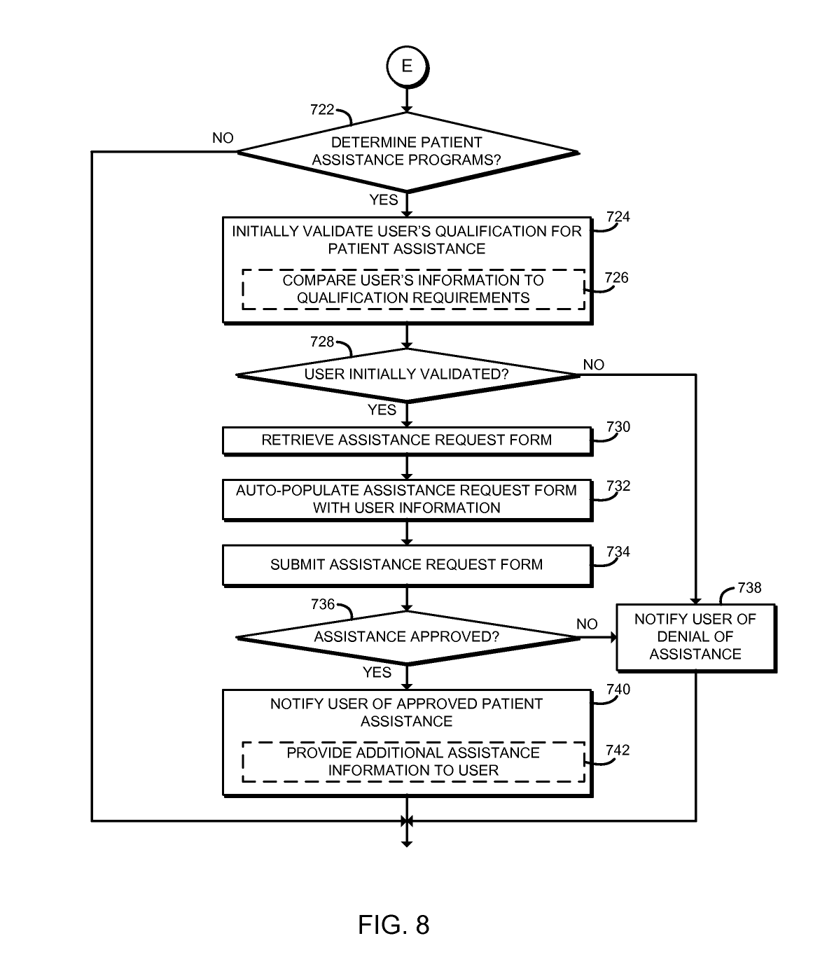

Subsequently, in block 340, the prescription management server 102 transmits an adjustment request to the insurance payer processor server 106 to cancel or “back-out” the previous submission of the prescription payment submission form. The adjustment cancels the submission request. It should be appreciated that by submitting the adjustment to cancel the previous prescription payment submission, the prescription management server 102 is able to determine co-pay and prior authorization information for a drug prescription without actually completing the payment submission. In this way, a user of the client computing device may sample the overall costs (i.e., costs including co-pays) of various different drugs, such brand-name and generic forms of a drug, prior to filling the prescription. Additionally, as discussed in more detail below, the user of the client computing device 104 is able to identify whether a particular drug or prescription would require a prior authorization. Further, in some embodiments, the prescription management server 102 may determine patient assistance information for the user in block 342. Such patient assistance information may include the availability of any manufacturer vouches or assistance services that may be available to the user. The determination of such patient assistances information is discussed in more detail below in regard to FIGS. 7 and 8.

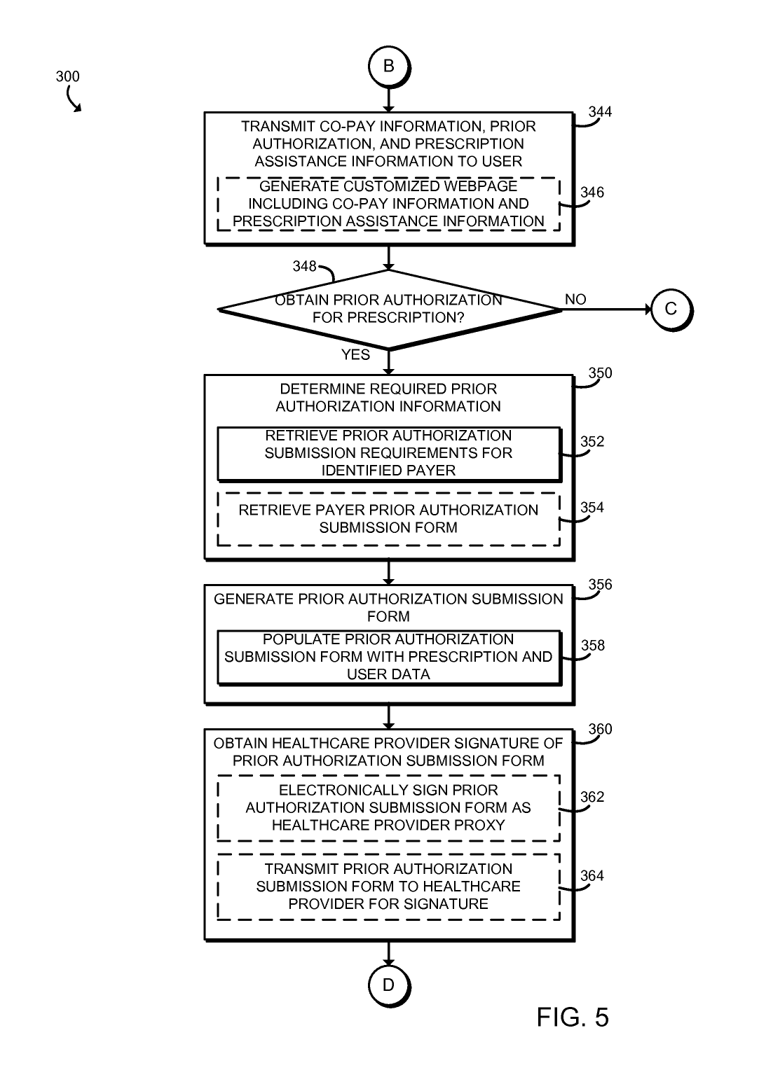

After the prescription management server 102 has received any co-pay information, prior authorization information, and/or prescription assistance information, the prescription management server 102 transmits such information to the client computing device 104 in block 344 (see FIG. 5). To do so, in some embodiments, the prescription management server 102 may generate a customized webpage including the co-pay information, prior authorization information, and/or prescription assistance information in block 346. In some embodiments, the webpage may be customized by a drug manufacturer or based on parameters provided by the drug manufacturer. Additionally, in some embodiments, the webpage generated in block 346 may include links directing the user to a website maintained by one of the drug manufacturer servers 108 (e.g., to obtain a manufacturer voucher).

As discussed above, in some embodiments, the prescription management server 102 may receive prior authorization information from the insurance payer processor server 106. As such, the prescription management server 102 determines whether the user desires to obtain a prior authorization for the drug prescription in block 348. If no prior authorization is required or the user does not desire to obtain the prior authorization, the method 300 loops back to block 306 (see FIG. 3) in which the prescription management server 102 determines whether the user desires to determine a co-pay requirement for another drug or drug prescription.

However, if the user of the client computing device 104 desires to obtain a prior authorization in block 348, the method 300 advances to block 350. In block 350, the prescription management server 102 determines any information required to obtain a prior authorization for the prescription. For example, in block 352, the prescription management server 102 may retrieve prior authorization submission requirements for the identified insurance payer, which may be stored in the data storage 118. Additionally, in some embodiments, the prescription management server 102 may retrieve a prior authorization submission form in block 354. The prescription management server 102 may retrieve the prior authorization submission form from, for example, the authorization form database 220 or from the insurance payer processor server 106. The prior authorization form may be customized by or for each particular insurance payer. Alternatively, in block 356, the prescription management server 102 may generate the prior authorization submission form based on the prior authorization submission requirements determined in block 352. Regardless, in block 358, the prescription management server 102 may pre-populate the authorization submission form with various data such as, for example, identification data of the user, prescription information, healthcare provider information, insurance payer information, and/or the like.

In block 360, the prescription management server 102 obtains a signature of the user's healthcare provider on the prior authorization submission form. To do so, in some embodiments, the prescription management server 102 may be preapproved to electronically sign the prior authorization submission on the behalf of the healthcare provider. Alternatively, the prescription management server 102 may transmit a copy of the prior authorization submission form to the healthcare provider for signature in block 364. For example, the prescription management server 102 may fax, e-mail, or otherwise electronically send the prior authorization submission form to the healthcare provider for signing.

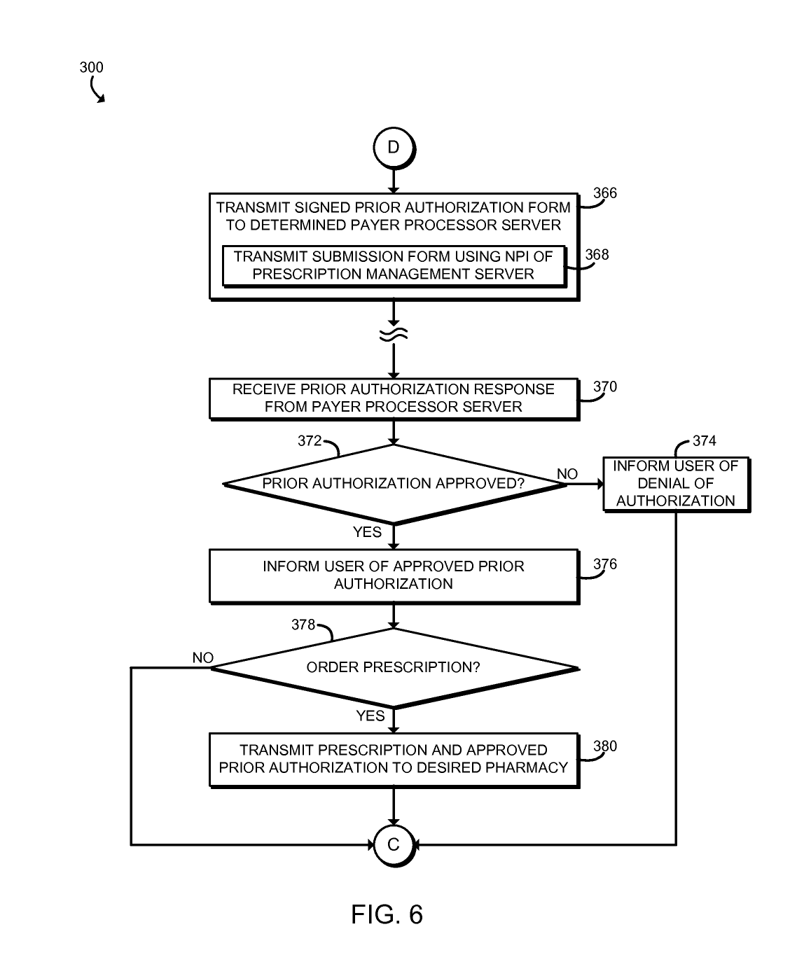

After the prescription management server 102 has obtained the signature of the healthcare provider on the prior authorization form in block 360, the method 300 advances to block 366 (see FIG. 6). In block 366, the prescription management server 102 transmits the signed prior authorization form to the insurance payer processor server 106 determined in block 330. To do so, the prescription management server 102 may transmit the signed prior authorization form using the National Provider Identification (NPI) associated with the prescription management server 102 or company maintaining the server 102 in block 368.

After the prescription management server 102 has submitted the prior authorization submission form to the insurance payer processor, the insurance payer processor will process the prior authorization to determine if the prior authorization is granted. As such, in block 370, the prescription management server 102 receives a prior authorization response form the insurance payer processor server 106. In block 372, the prescription management server 102 determines whether the prior authorization is approved. If not, the method 300 advances to block 374, in which the prescription management server 102 notifies the user of the client computing device 104 that the prior authorization has been denied. The method subsequently loops back to block 306 (see FIG. 3) in which the prescription management server 102 determines whether the user desires to determine a co-pay requirement for another drug or drug prescription.

If, however, the prior authorization is approved, the method 300 advances to block 376 in which the prescription management server 102 notifies the user of the client computing device 104 of the approval of the prior authorization. The method 300 subsequently advances to block 378 in which the prescription management server 102 determines whether the user would like to order the prescription. If so, the method 300 advances to block 380 in which the prescription management server 102 transmits the proscription and approved prior authorization (if required) to a pharmacy selected by the user of the client computing device 104. In this way, the prescription management server 102 facilitates management of drug prescriptions for the user of the client computing device 104.

Referring now to FIGS. 7 and 8, as discussed above, the prescription management server 102 may execute a method 700 for determining patient assistance information for the user of the client computing device 104. The method 700 may be executed as part of the execution of block 342 of method 300 or as a stand-alone method. The method 700 begins with block 702 in which the prescription management server 102 determines whether the user of the client computing device 104 desires the prescription management server 102 to determine patient assistance information. If so, the method 700 advances to block 704 in which the prescription management server 102 determines the availability of any prescription vouchers. To do so, for example, the prescription management server 102 may communicate with one or more of the drug manufacturer servers 108 to determine the availability of any voucher for the particular drug prescribed in the drug prescription in block 706. Additionally or alternatively, in block 708, the prescription management server 102 may analyze locally stored data to determine the availability of any prescription vouchers (e.g., the prescription management server 102 may store drug manufacturer vouchers in the data storage 118). Further, in block 710, the prescription management server 102 may update any loyalty program maintained by the drug manufacturer to thereby determine the availability of any drug manufacturer vouchers. Of course, the prescription management server 102 may utilize any additional or other methodology for determining or identity vouchers usable by the user of the client computing device 104 in block 704.

In block 712, the prescription management server 102 determines whether any vouchers are available. If not, the method 700 loops down to block 722 (see FIG. 8) described below. However, if the prescription management server 102 determines that one or more vouchers are available for the particular drug or drug prescription, the method 700 advances to block 714 in which the prescription management server 102 facilitates the user of the identified voucher(s) for the user of the client computing device 104. For example, in block 716, the prescription management server 102 may link the user to a drug manufacturer website maintained by one of the drug manufacturer servers 108 or the prescription management server 102 itself. Additionally or alternatively, the prescription management server 102 may obtain the voucher and auto-populate the voucher in block 718 with information such as, for example, identification information of the user, healthcare provider, prescription, insurance payer, and/or other information obtainable by the prescription management server 102. Further, in some embodiments, the prescription management server 102 may transmit a completed voucher to the relevant drug manufacturer server 108 in block 720. In this way, the prescription management server 102 facilitates the use of drug prescription vouchers for the user of the client computing device 104.

In block 722 (see FIG. 8), the prescription management server 102 determines whether the user desires to determine the availability of any patient assistance programs If so, the method 700 advances to bock 724. In block 724, the prescription management server 102 initially validates the user for patient assistance. For example, in block 726, the prescription management server 102 may compare the user's information (e.g., financial information, age, and/or other information) to qualification requirements maintained by the prescription management server 102 or obtainable thereby. In block 728, the prescription management server 102 determines whether the user has been initially validated. If not, the method 700 advances to block 738 in which the prescription management server 102 notifies the user of denial of any patient assistance services or programs, and the method 700 subsequently exits.

However, if the user is initially validated in block 728, the method 700 advances to block 730 in which the prescription management server 102 retrieves an assistance request form. The prescription management server 102 may retrieve such request forms from the data storage 118 or from a remote server (e.g. a server maintained by a patient assistance agency). In block 732, the prescription management server 102 auto-populates the assistance request form with information such as, for example, identification information of the user, healthcare provider, prescription, insurance payer, and/or other information obtainable by the prescription management server 102. The auto-populate the voucher in block 718 with information such as, for example, identification information of the user, healthcare provider, prescription, insurance payer, and/or other information obtainable by the prescription management server 102.

Subsequently, in block 734, the prescription management server 102 submits the completed assistance request form to the assistance agency. In block 736, the prescription management server 102 determines whether the requested assistance has been approved. If not, the method 700 advances to block 738 in which the prescription management server 102 notifies the user of denial of the patient assistance, and the method 700 subsequently exits. If, however, the requested assistance has been approved in block 736, the method 700 advances to block 740 in which the prescription management server 102 notifies the user of the client computing device 104 of the approval of the requested patient assistance. Additionally, in some embodiments, the prescription management server 102 may provide additional assistance information to the user in block 742, such as a link to the patient assistance agency or provider. In this way, the prescription management server 102 facilitates the discovery and user of patient assistance services and programs by the user of the client computing device 104.

1. A method for managing a drug prescription, the method comprising:
determining, by a prescription management server, an identity of an insurance payer for the drug prescription;
determining, by the prescription management server, submission requirements to submit a prescription of a user to the insurance payer for payment based on the identity of the insurance payer;
generating, by the prescription management server, a prescription payment submission form customized for the insurance payer based on the submission requirements;
populating, by the prescription management server, the prescription payment submission form with prescription information of the prescription and identification information of the user;
submitting, by the prescription management server, the populated prescription payment submission form to an insurance payer processor server;
receiving, from the insurance payer processor server, prescription co-pay information related to the prescription in response to submitting the prescription payment submission form;
submitting, by the prescription management server and in response to receiving the co-pay information, an adjustment to the insurance payer processor server to cancel the submission of the prescription payment submission form; and
notifying, by the prescription management server, the user of the prescription co-pay information.

2. The method of claim 1, wherein determining submission requirements comprises retrieving the submission requirements from a payer information database managed by the prescription management server based on the identity of the insurance payer, the payer information database identifying submission requirements for a plurality of insurance payers.

3. The method of claim 1, wherein generating the prescription payment submission form comprises modifying an electronic claim submission (ECS) field of the prescription payment submission form based on the identity of the insurance payer.

4. The method of claim 1, wherein populating the prescription payment submission form comprises populating an electronic claim submission (ECS) field of the prescription payment submission form based on at least one of the prescription information of the prescription, the identification information of the user, or the identity of the insurance payer.

5. The method of claim 1, wherein submitting the populated prescription payment submission form comprises identifying an insurance payer processor to process the populated prescription payment submission based on the identity of the insurance payer.

6. The method of claim 1, wherein submitting the populated prescription payment submission form comprises submitting the populated prescription payment submission form to an insurance payer processor server using a National Provider Identification (NPI) associated with the prescription management server.

7. The method of claim 1, further comprising determining, by the prescription management server, whether a prior authorization for the prescription is required by the insurance payer based on the prescription information of the prescription and the identity of the insurance payer.

8. The method of claim 7, wherein determining whether a prior authorization for the prescription is required comprises receiving, from the insurance payer processor server, a notice that the prior authorization is required in response to submitting the prescription payment submission.

9. The method of claim 7, further comprising:
determining, by the prescription management server and in response to determining that the prior authorization is required, authorization information required by the insurance payer to obtain the prior authorization;
generating, by the prescription management server, a prior authorization submission form based on the authorization information;
obtaining, by the prescription management server, a healthcare provider's approval of the prior authorization submission form; and
submitting, by the prescription management server, the prior authorization submission form to the insurance payer processor server in response to obtaining the healthcare provider's approval for the prior authorization form.

10. The method of claim 9, wherein obtaining the healthcare provider's approval of the prior authorization submission form comprises transmitting the prior authorization submission form to the healthcare provider and receiving a signed prior authorization submission form from the healthcare provider.

11. The method of claim 9, further comprising:
receiving, by the prescription management server, a prior authorization approval of the insurance payer from the insurance payer processor server; and
notifying, by the prescription management server, the user of the prior authorization approval.

12. The method of claim 1, further comprising:
determining, by the prescription management server, an availability of a prescription voucher for the prescription;
obtaining, by the prescription management server, a voucher form for submitting the prescription voucher for reimbursement;
populating, by the prescription management server, the voucher form based on the identification information of the user, and
submitting, by the prescription management server, the voucher form to a drug manufacture server of a drug identified by the prescription.

13. The method of claim 1, further comprising:
determining, by the prescription management server, whether the user qualifies for patient assistance;
obtaining, by the prescription management server, a patient assistance request form;
populating, by the prescription management server, the patient assistance request form based on the identification information of the user and the prescription information of the prescription; and
submitting, by the prescription management server, the assistance submission request form.

14. A prescription management server comprising:
a patient benefit verification module configured to (i) determine an identity of an insurance payer for the drug prescription, (ii) determine submission requirements to submit a prescription of a user to the insurance payer for payment based on the identity of the insurance payer, (iii) generate a prescription payment submission form customized for the insurance payer based on the submission requirements, (iv) populate the prescription payment submission form with prescription information of the prescription and identification information of the user, and
a communication module configured to (i) submit the populated prescription payment submission form to an insurance payer processor server and (ii) receive, from the insurance payer processor server, prescription co-pay information related to the prescription in response to submitting the prescription payment submission form,
wherein the patient benefit verification module is further to generate an adjustment to cancel the submission of the prescription payment submission form and notify the user of the prescription co-pay information,
wherein the communication module is further to submit the adjustment to the insurance payer processor server.

15. The prescription management server of claim 14, further comprising a payer information database that identifies submission requirements for a plurality of insurance payers,
wherein to determine the submission requirements comprises to retrieve the submission requirements from the payer information database based on the identity of the insurance payer.

16. The prescription management server of claim 14, wherein to generate the prescription payment submission form comprises to modify an electronic claim submission (ECS) field of the prescription payment submission form based on the identity of the insurance payer.

17. The prescription management server of claim 14, wherein to populate the prescription payment submission form comprises to populate an electronic claim submission (ECS) field of the prescription payment submission form based on at least one of the prescription information of the prescription, the identification information of the user, or the identity of the insurance payer.

18. The prescription management server of claim 14, wherein the patient benefit verification module is further configured to identify an insurance payer processor to process the populated prescription payment submission based on the identity of the insurance payer.

19. The prescription management server of claim 14, wherein to submit the populated prescription payment submission form comprises to submit the populated prescription payment submission form to an insurance payer processor server using a National Provider Identification (NPI) associated with the prescription management server.

20. The prescription management server of claim 14, further comprising a prescription prior authorization module configured to determine whether a prior authorization for the prescription is required by the insurance payer based on the prescription information of the prescription and the identity of the insurance payer.

21. The prescription management server of claim 20, wherein to determine whether a prior authorization for the prescription is required comprises to receive, from the insurance payer processor server, a notice that the prior authorization is required in response to submitting the prescription payment submission.

22. The prescription management server of claim 20, wherein the prescription prior authorization module is further configured to:
determine, in response to a determination that the prior authorization is required, authorization information required by the insurance payer to obtain the prior authorization;
generate a prior authorization submission form based on the authorization information; and
obtain a healthcare provider's approval of the prior authorization submission form,
wherein the communication module is further to submit the prior authorization submission form to the insurance payer processor server in response to the healthcare provider's approval of the prior authorization form.

23. The prescription management server of claim 22, wherein to obtain the healthcare provider's approval of the prior authorization submission form comprises to transmit, by the communication module, the prior authorization submission form to the healthcare provider and receive, by the communication module, a signed prior authorization submission form from the healthcare provider.

24. The prescription management server of claim 22, wherein:
the communication module is further configured to receive a prior authorization approval of the insurance payer from the insurance payer processor server, and
the prescription prior authorization module is configured to notify the user of the prior authorization approval.

25. The prescription management server of claim 14, further comprising a patient assistance module configured to:
determine an availability of a prescription voucher for the prescription;
obtain a voucher form for submitting the prescription voucher for reimbursement; and
populate the voucher form based on the identification information of the user,
wherein the communication module is further to submit the voucher form to a drug manufacture server of a drug identified by the prescription.

26. The prescription management server of claim 14, further comprising a patient assistance module configured to:
determine whether the user qualifies for patient assistance
obtain a patient assistance request form; and
populate the patient assistance request form based on the identification information of the user and the prescription information of the prescription,
wherein the communication module is configured to submit the assistance submission request form.
